(19) United States
(12) Patent Application Publication
(10) Pub. No.: US 2021/0339927 A1
(43) Pub. Date: Nov. 4, 2021

(54) BIODEGRADABLE PACKAGING FOR SHIPPING

(71) Applicant: Frontier Paper & Packaging Incorporated, Indianapolis, IN (US)

(72) Inventor: James Branham, Brownsburg, IN (US)

(73) Assignee: Frontier Paper & Packaging Incorporated, Indianapolis, IN (US)

(21) Appl. No.: 17/305,339

(22) Filed: Jul. 6, 2021

Related U.S. Application Data
(63) Continuation of application No. 16/551,369, filed on Aug. 26, 2019, now abandoned.
Application No. 16/551,369 is a continuation of application No. 14/464,281, filed on Aug. 20, 2014, now abandoned.

(51) Int. Cl. B65D 65/46; B32B 5/18; B32B 23/04

(52) U.S. Cl. CPC B65D 65/466; B32B 5/18; B32B 2439/02; B32B 2307/7163; B32B 2266/02; B32B 23/048

(57) ABSTRACT

A biodegradable, thermally insulated mailer and cooler, and method of making them, are disclosed. The thermally insulated packaging material are made from laminated starch foam and bio-plastic film. The lamination can be performed by heat bonding, without the use of an adhesive bonding agent, to produce biodegradable packaging materials that can pass ASTM and other certifications for home compostability and marine environment safety.

### CROSS REFERENCE TO RELATED APPLICATIONS

This application is a continuation of U.S. application Ser. No. 16/551,369, filed Aug. 26, 2019 which is a continuation of U.S. application Ser. No. 14/464,281, filed Aug. 20, 2014, which is hereby incorporated by reference.

### TECHNICAL FIELD OF THE INVENTION

The present invention generally relates to biodegradable packaging for shipping, and, more specifically, to biodegradable shipping envelopes, coolers, and the like for shipping temperature-sensitive materials.

### BACKGROUND OF THE INVENTION

The shipping and mailing industry offers a wide range of products and services today in order to provide efficient and effective transportation of a wide range of cargoes via both private carriers and the federal postal system. These products include a large variety of packaging designed to protect valuable cargoes, from impact, crushing, spoilage, and so forth.

Cargoes that are thermally sensitive have been a substantial and growing portion of the cargoes being shipped. Such cargoes include, for example, food products, such as sea foods, and a variety of medical products, including insulin or insulin replacements. The ability to package such cargoes so that the shipper can be assured that the products will remain adequately refrigerated for 48 to 72 hours greatly improves the economy with which such products can be shipped, because it obviates the need for overnight shipping, and allows handling of such packages according to more standard shipping practices. This greatly reduces the overall cost of the shipping, as long as the cost of the packaging remains relatively modest. Thus, this sector of the shipping industry has been a rapidly expanding sector.

Unfortunately, existing products that have facilitated the shipping of temperature-sensitive cargoes tend to be especially problematic for the environment. For example, expanded polystyrene (e.g. Styrofoam®) packaging, a common insulating material, is problematic in terms of both its production and disposal (it includes benzene; furthermore, it outgases, which can be dangerous in and of itself, and causes it to loose R-value). It requires nearly 700 gallons of oil to produce one ton of expanded polystyrene, it generally cannot be economically recycled, it is generally lethal to any creature that ingests a significant quantity, and, in the absence of expensive procedures (which, as a practical matter, are never employed) it does not decompose in any reasonable time period.

Biodegradable alternatives to expanded polystyrene have been developed, but they remain generally unacceptable alternatives. For example, PLA (polylactic acid) is for at least some applications a suitable drop-in replacement for polystyrene. However, it will biodegrade only in commercial facilities, and it suffers from manufacturing inconsistencies, especially in the manufacturing of thicker sheets, which render it unacceptable for many packaging applications. For another example, foam made from corn starch exists, but it is generally unacceptable as shipping material, both because contact with moisture causes the material to degrade, and because the material in its dry form “sands,” i.e., it abrades, damaging the structural integrity of the material and producing small particulate waste. In addition to the resulting structural degradation, the resulting waste is problematic, both aesthetically and from a practical perspective. There is, therefore, a substantial need in the industry for acceptable materials for shipping thermally sensitive cargoes which do not pose environmental problems. The present invention is directed to meeting this need.

### BRIEF DESCRIPTION OF THE DRAWINGS

FIG. 1 is a diagram of a first embodiment shipping envelope, shown before assembly.

FIG. 2 is a diagram of a first embodiment shipping envelope, shown after assembly and before sealing.

FIG. 3A is a diagram of a composite made by laminating multiple sheets of biodegradable foam, suitable for making a second embodiment biodegradable cooler.

FIG. 3B shows a joint in a composite sheet suitable for forming the corner of a second embodiment biodegradable cooler or box-liner.

FIG. 4A is a plan view of a top for a second embodiment biodegradable cooler or box-liner.

FIG. 4B is a side view of a top for a second embodiment biodegradable cooler or box-liner.

FIG. 5 is a perspective view of a second embodiment biodegradable cooler with the top removed.

### DETAILED DESCRIPTION OF THE INVENTION

For the purposes of promoting an understanding of the principles of the invention, reference will now be made to the embodiments illustrated in the drawings and specific language will be used to describe the same. It will nevertheless be understood that no limitation of the scope of the invention is thereby intended, and alterations and modifications in the illustrated devices and methods, and further applications of the principles of the invention as illustrated therein are herein contemplated as would normally occur to one skilled in the art to which the invention relates.

The United States has adopted standards defining test standards for labeling a product “biodegradable and compostable,” ASTM D6400. This standard establishes a standard of industrial compostability, but this standard only establishes compostability at temperatures higher than are typically achieved in private composting. Consequently, products that satisfy this standard may not properly break down if consumers put them in their home compost heaps. Products that will break down in the typical conditions of a private compost heap are therefore desirable. Nonetheless, the U.S. has not adopted standards for labeling a product “home compostable.” Europe has adopted some such standards, but they vary by region. Although bio-degradability and compostability are currently established by separate standards in Europe, for the purpose of this document the term “bio-degradable” will be used to refer generally to the class of environmentally friendly standards, without distinction.

In view of present public attention to the subject, it is expected that the United States will adopt the standard employed by the European Union, known as EN 13432, or a comparable standard, for bio-degradability. That standard requires that 90% of the product, by mass, is converted to CO2 within 6 months, and that after 3 months of composting and subsequent sifting through a 2 mm sieve no more than 10% residue, by mass, remains. Composite packaging materials satisfy this standard only if every component from which they are made satisfies these criteria. Thus, for example, a composite packaging material made from a substrate that is 99% converted to CO2 and a surfacing agent that is only 85% converted to CO2 cannot be rendered “biodegradable” merely by changing the proportions of the mass of the substrate and surfacing agent. Composite packaging materials according to the disclosed embodiments have been found to meet the EN 13432 standard, and are therefore acceptable for labeling as “biodegradable” and “compostable” for shipping to Europe.

Although newer and better biodegradable and compostable materials are being developed all the time, existing biodegradable materials still lack physical characteristics of the packaging materials that we are seeking to replace. For example, bio-plastic films that might otherwise replace conventional plastics are weak, tend to tear, and to propagate tears once formed. This tends to render them unsuitable for many commercial shipping applications.

Similarly, corn starch foam is biodegradable and compostable, and can provide suitable insulation for general purpose thermal-sensitive shipping packaging. It will be appreciated by those skilled in the art, however, that corn starch foams are not generally acceptable insulators for shipping applications. In their dry form, and unlike expanded polystyrene and other such petroleum-based products, corn starch foams tend to “sand.” That is, when the material rubs against itself or its environment, it tends to abrade, producing sand-like particles, and eroding the material. Furthermore, contact with any moisture, such as the condensation that develops when a cooled package is exposed to high humidity, causes the material to degrade. This can completely destroy the thermally insulating properties.

It has been discovered, however, that corn starch foams can be rendered suitable for shipping applications by protecting it within a film that protects the material from moisture and from friction with the surrounding environment. Potential organic films include cellulose-based films, starch, PLA (polylactic acid) films, and PHA (polyhydroxyalkanoate) films. PCL, or polycapralactones, PVA, or polyvinylalcohol, and EVOH, or ethylene vinyl alcohol, are petroleum-based but biodegradable films, that would also be potential candidates. A suitable film must be sufficiently strong to resist tearing or breaking, and ideally, will not propagate tears once started. More importantly, in order for the resulting packaging to retain its biodegradable properties, the protective film must, of course, itself be biodegradable.

Bioplastic films provide a suitable film for enclosing corn starch foam to provide biodegradable and home-compostable packaging for shipping. For example, a favorable result can be provided by the use of potato-based bioplastic film. For one example, a particularly suitable potato-based bioplastic is LTBio, produced by and available from CeeT UK, 31 Mount Street, Manchester, M27 5NG, United Kingdom. Other suitable films are commercially available from Danimer Scientific, 1301 Colquitt Highway, P.O. Box 7965, Bainbridge, Ga. 39818 (www.danimer.com), and Biome Technologies, North Raod, Marchwood Industrial Park, Marchwood, Southampton, UK SO40 4BL (www.biometechnologiesplc.com). Packaging that combines corn starch foams and organic bioplastic films have been found to sufficiently degrade within 90 to 180 days, when in contact with the microorganisms commonly found in the ground, and especially in compost environments. However, such composite materials are sufficiently resistant to water and other environmental factors to maintain their integrity for at least 7 days. As such, these composites provide for the construction of commercially acceptable packaging for shipping, yet conform to the highest standards of biodegradability presently in force (including “aerobic biodegradability in a marine environment,” ASTM D6691).

While enclosing the corn starch foam in such a potato-based film can provide functional packaging, it will be appreciated that the film needs to be adhered to the underlying foam substrate. This process is generally performed by a wet laminator. A film and substrate are fed into the laminating machine with a heat-activated bonding agent that adheres the two. Of course, in order for the resulting packaging to retain its biodegradable properties, the adhesive bonding agent used to bond the film to the substrate must itself be biodegradable. This poses a critical problem, as there is, at present, no known bonding agent that is home compostable, and so there is no known way to laminate layers in a way that satisfies ASTM 6400 (for example). It has been discovered, however, that this problem can be overcome by heat bonding a specific starch film to a specific film, without any bonding agent. Surprisingly, the combination of the specific film and substrate react to the heat to produce a heat bond directly, with no need for the bonding agent that is usually required.

The desired corn starch foam is an extruded, high amylose content foam, at least about 90% corn starch, by weight. The high amylose content provides for greater strength and flexibility. A suitable non-GMO corn starch foam is Green Cell Foam™ provided by KTM Industries, 3327 Ranger Rd., Lansing, Mich. 48906 (www.ktmindustries.com). Green Cell Foam™ is typically sold in corrugated, extruded planks.

The desired film is a bio-based biodegradable bio-plastic. Although higher carbon-neutral content is desirable, petroleum-based bio-plastics are acceptable, as long as they have the other desired features. The ideal film is Danimer 12291, a bio-polymer resin film that is that sold by Danimer Scientific, 1301 Colquitt Highway, P.O. Box 7965, Bainbridge, Ga. 39818 (www.danimer.com). Danimer 12291 is a compostable (tested according to ASTM D6400-04, EN 14332 (2000), and ISO 17088 (2008) standards), sold for such applications as trash bags, agricultural mulch film, greenhouse films, compost bags, hay bale wraps, etc. Danimer's film is unique, at the moment, in that it is certified as safely “biodegradable in marine environments.” (The certification is by Experimental Station Scientific Paper, Carboard and Pulp, or SSCCP, of Milan. It has not yet been certified under the ASTM standard, in part because the standard was adopted after SSCCP certification was initiated; it is believed that it also satisfies the ASTM standard, and will receive that certification in due course. Note that its renewable bio-content is about 30%—the remainder is made up of a biodegradable petroleum based material.)

The corn starch foam is compressed into a thin, flexible sheet—referred to as “paper”—by rolling it through rollers. (The rollers are arranged like an old laundry wringer, or “mangle.”) Multiple sheets can be laminated together to create paper with a greater thickness, cushioning, insulation, etc., if desired. The corn starch paper is then die-cut, including desired perforations (such as for a tear-strip for opening the mailer). The film and paper are then c-folded, with the film on either side of the paper, and run through the lamination machine without an adhesive bonding agent, to produce the composite paper. Application of a fine water mist may assist in achieving a consistent bonding between paper and film, but is not believed to operate as an adhesive. The composite paper is then folded up to form the mailer. A paper tongue is inserted into the interior to prevent face-to-face heat sealing from closing the interior, and the mailer is re-run through the laminator.

The bonding of the film to the paper is sensitive to temperature and to the speed with which the sheets are fed through the laminator. Obviously, it is desirable, for commercial reasons, to feed the sheets at the highest practicable speed. However, higher temperatures are required to more rapidly bond the film to the paper. On the other hand, at a certain point, higher temperatures become counter-productive. It has been discovered through experimentation that the best bond is achieved with a laminator feed rate of 22 feet/s, and a bonding temperature of 253° F. A suitable bond can be achieved with a feed rate of 31 feet/s and a bonding temperature of 253° F. An acceptable but inferior bond can be achieved with a feed rate of 36 feet/s and a bonding temperature of 258° F. A less desirable bond still can be achieved with a feed rate of 36 feet/s and a bonding temperature of 248° F. Generally, the resulting bond will not be suitable unless the bonding temperature is above about 225° F.

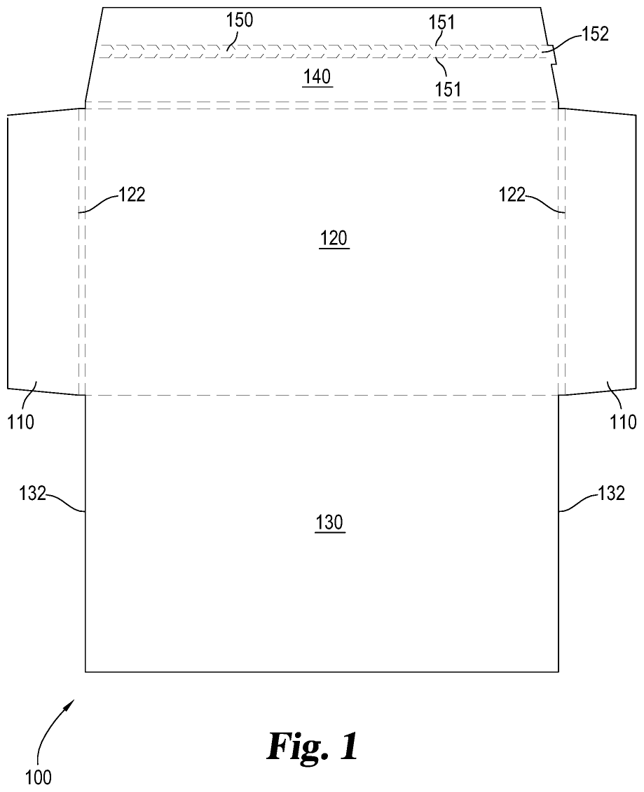

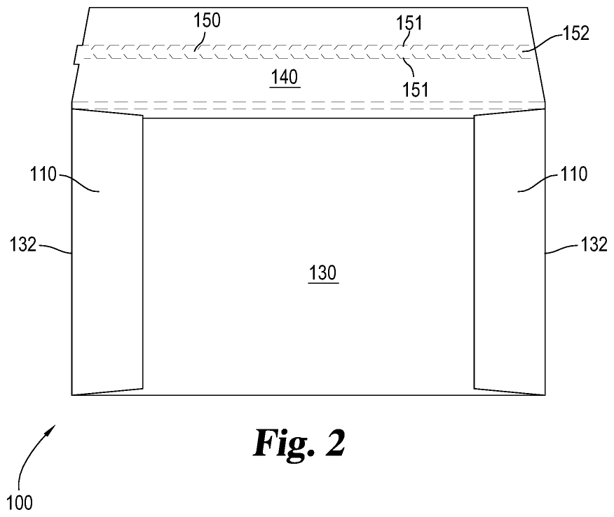

FIGS. 1 and 2 illustrates a first embodiment biodegradable shipping envelope, indicated generally at 100, shown before and after assembly into an envelope, respectively. Side tabs 110 hold the side edges 122 of the front 120 to the side edges 132 of the back 130 to form a pouch. A top tab 140 can be folded over to seal the envelope 100 (by any suitable adhesive means, such as a strip of double-sided tape along the top edge). The top tab advantageously includes a pull-strip 150, comprising two parallel rows of perforations 151 and a small pull-tab 152, which allows for easy opening of the sealed envelope 100.

In order to produce envelopes suitable for commercial applications, the film can advantageously be flexographically printed, using water soluble, bio-degradable and/or compostable inks, prior to bonding to the paper. Such printing advantageously includes a commercial graphic design incorporating information on the biodegradability and/or compostability standards satisfied by the product, in addition to the vendor's trademark information.

It will be appreciated that a biodegradable composite film can be use to make a variety of other shipping containers, as would occur to those of skill in the art. For example, in another aspect, the composite paper can be cut in the same fashion as corrugated cardboard into the pattern for cardboard boxes, in order to make convenient, biodegradable boxes that can be shipped, stacked, and otherwise used in the same fashion as a standard cardboard container. In this way, for example, convenient wine shippers can be made, including 1-, 3-, and 5-bottle wine shippers. In still another aspect, the composite paper can be used to make bait containers, such as are typically used by fishermen during recreational fishing. In this context, biodegradability, especially in a marine environments, is a key advantage over existing bait containers.

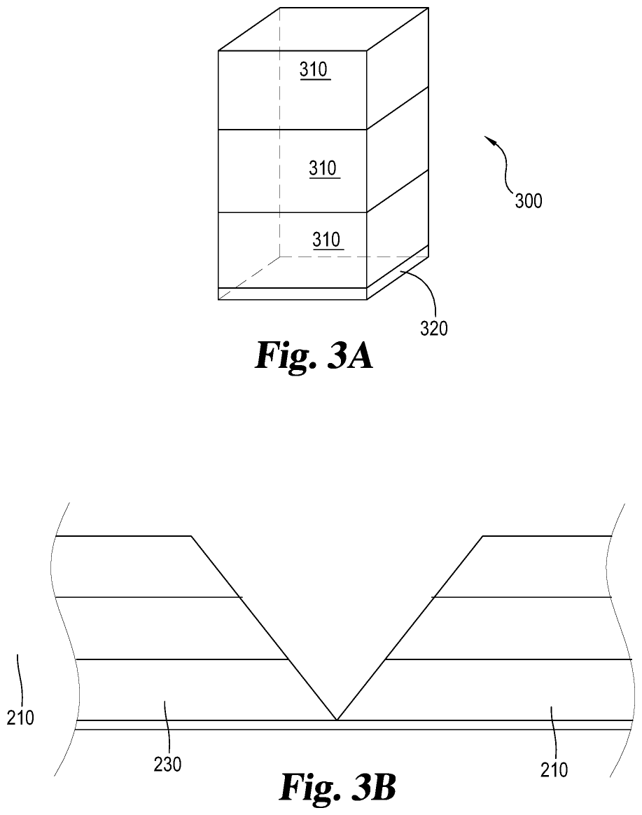

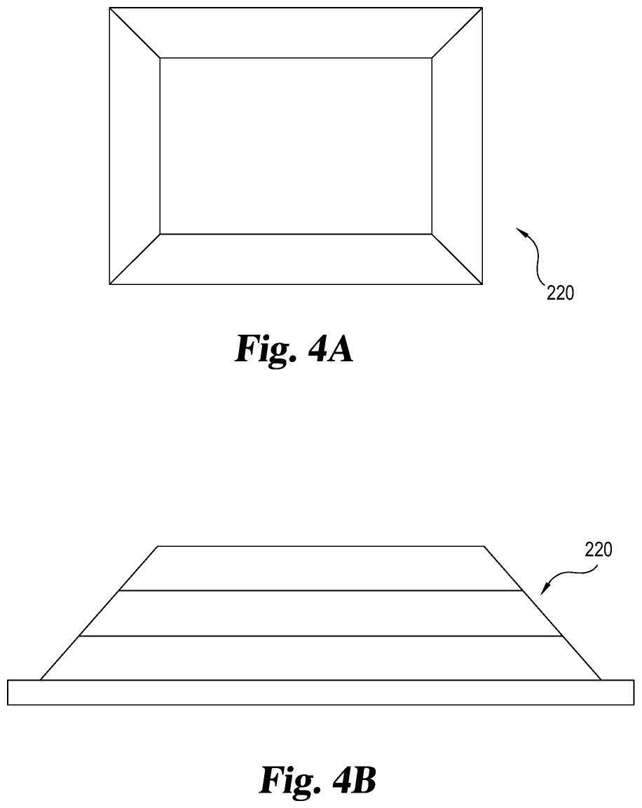

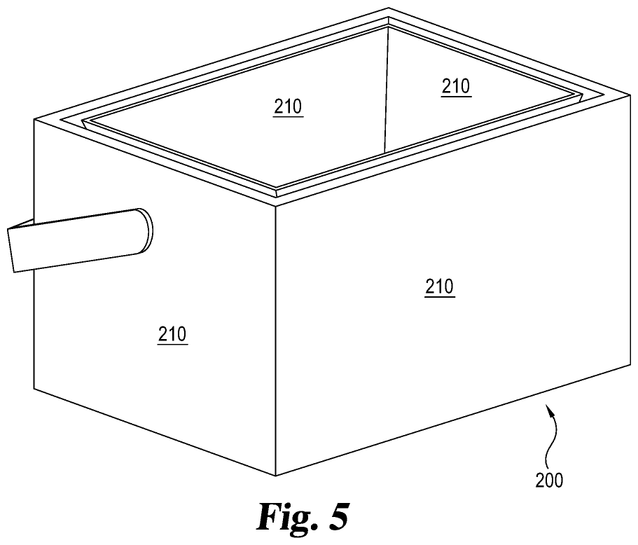

FIG. 5 illustrates a first embodiment biodegradable shipping cooler 200, suitable for more voluminous or more temperature-sensitive cargoes. The cooler 200 comprises four sides 210, a top 220, (shown in FIGS. 4A and 4B) and a bottom 230, (not visible) each of which is formed from corn starch foam panels. Typically, corn starch foams are extruded into ½ inch corrugated sheets, and it will often be desirable for the panels to be thicker than this, in order to provide the desired insulation properties. When this is the case, the corn starch panels are formed by laminating two or more sheets together (using a starch-based adhesive), to produce a composite material, illustrated in FIG. 3A, and indicated generally at 300. The illustrated composite 300 comprises three corn starch foam sheets 310 laminated together, and a fourth, “paper” sheet 320, made by rolling a corn starch foam sheet and heat bonding a film, as described above, laminated to one side. The film side of the paper sheet 320 will form the outside of the finished cooler 200.

The composite 300 is placed, film side-up, on a mitering table, and the foam sheets are mitered to allow the composite to be “rolled up” into the four sides of the cooler. By cutting away the foam, while leaving the paper intact, the paper forms a “hinge”—a flexible connection between the foam panels, which served both to seal a corner of the assembled cooler, and to hold the panels together to assist in the assembly of the cooler. It will be appreciated that the precise pattern cut by the miter saw is not critical, but a simple, workable pattern is to cut the foam sheets into four equal panels, each having a simple 45 degree miter on either side. This will produce a cubical cooler 200, but, again, this can be varied as desired.

The top 220 and bottom 230 are typically made from the same composite 300 as the sides 210. While in theory, they could be attached to the same paper substrate as the sides 210, in practice the corn starch foam is commercially available in a limited width (constrained by the dimensions of the extruding machinery), and this imposes an overall limit on the size of the paper—typically 18 inches in maximum width. Consequently, the top 220 and bottom 230 must either be attached to the sides 210 by a separate paper sheet (meaning an additional laminating pass that bonds the paper holding the side panels 210 together with a paper holding the top 220 and bottom 230), or they must remain a separate piece. The latter option is suitable, for example, if the cooler is intended to be used as a box-liner, i.e., if the cooler is intended to add thermal insulation for a standard cardboard box.) The top 220 and bottom 230 are advantageously mitered to fit snugly against the edges of the sides 210. Preferably, though, these miter cuts are 90° cuts (to create an edge lip that prevents the top 220 and bottom 230 from falling into the interior), so that matching miter cuts are not required along the top and bottom edges of side panels 210.

It will be appreciated that the biodegradable foam-film composite can be used to make biodegradable coolers in other ways, as would occur to those of skill in the art. For example, a pair of 3-panel composite pieces can be used to add thermal insulation to a standard cardboard. The 3-planel composites are inserted to form 2 interlocking “C” forms to provide thermal insulation for each of the box's six sides.

While the invention has been illustrated and described in detail in the drawings and foregoing description, the same is to be considered as illustrative and not restrictive in character, it being understood that only the preferred embodiment has been shown and described and that all changes and modifications that come within the spirit of the invention are desired to be protected.

1. A biodegradable mailer, made from a composite consisting essentially of:
a corn starch foam paper made from extruded foam having at least about 90% corn starch, by weight;
a bio-plastic film that is heat-bonded directly to the corn starch foam paper; and
compostable ink;
wherein the compostable ink is used to present information about biodegradability of the mailer.

2. The biodegradable mailer of claim 1, wherein the bio-plastic film is a bio-polymer resin film, and wherein the biodegradable mailer satisfies ASTM 6400.

3. The biodegradable mailer of claim 1, wherein the corn starch foam paper is made by compressing the high-amylose content foam into a flexible sheet.

4. The biodegradable mailer of claim 3, wherein the bio-plastic film is a bio-polymer resin film, and wherein the biodegradable mailer satisfies ASTM 6400.

5-20. (canceled)
